(19) United States
(12) Patent Application Publication
(10) Pub. No.: US 2026/0343172 A1
(43) Pub. Date: Oct. 29, 2026

(54) AUDIBLY NOTIFYING A USER

(71) Applicant: Telefonaktiebolaget LM Ericsson (publ), Stockholm (SE)

(72) Inventors: Peter ÖKVIST, LULEÅ (SE); Andreas KRISTENSSON, Lund (SE); Tommy Arngren, LULEÅ (SE); Till BURKERT, Stockholm (SE)

(73) Assignee: Telefonaktiebolaget LM Ericsson (publ), Stockholm (SE)

(21) Appl. No.: 19/107,264

(22) PCT Filed: Oct. 31, 2022
(86) PCT No.: PCT/EP2022/080378

§ 371 Date: Feb. 27, 2025

(51) Int. Cl. H04S 7/00; G10L 15/22

(52) U.S. Cl. CPC H04S 7/307; G10L 15/22

(57) ABSTRACT

A communications device for audibly notifying a user of the communications device is provided. The communications device comprises an acoustic actuator, and a processing circuitry. The processing circuitry causes the communications device to become operative to capture spoken utterances, estimate a current acoustic damping which the captured spoken utterances have been subjected to, and audibly notify the user by emitting an acoustic notification signal using the acoustic actuator. The current acoustic damping is estimated based on an amplitude of the captured spoken utterances and a maximum amplitude of previously captured spoken utterances. The acoustic notification signal is adapted based on the estimated current acoustic damping.

### TECHNICAL FIELD

The invention relates to a communications device for audibly notifying a user of the communications device, a method of audibly notifying a user of a communications device, a corresponding computer program, a corresponding computer-readable data carrier, and a corresponding data carrier signal.

### BACKGROUND

Known solutions for adapting an acoustic notification signal of a communications device like a smartphone, a mobile phone, a pager, or the like, are based on detecting the communications device is stored in a storage location such as a pocket or purse and increasing the volume of the notification signal to compensate for the acoustic damping resulting from placing the communications device in the storage location. The communications device may, e.g., detect its location inside a purse or pocket based on detecting that an ambient light intensity is below a threshold value, indicting a closed or covered storage location (see, e.g., U.S. Pat. No. 8,363,857 B2). Alternatively, the communications device may detect the proximity of NFC tags which are placed in different storage locations and thereby identify its current storage location (see, e.g., WO 2009/151833 A1). As a result of detecting that the communications device is in a storage location which may acoustically damp acoustic notifications signals emitted by the communications device, known solutions increase the volume of the notification signal, such as the volume of the ring tone when an incoming call is received, by a pre-configured amount.

The known solutions are disadvantageous in that the adjusted notification volume may be too low, if the acoustic damping in the storage location is relatively high, or too high, if the acoustic damping in the storage location is relatively low.

### SUMMARY

It is an object of the invention to provide an improved alternative to the above techniques and prior art.

More specifically, it is an object of the invention to provide an improved solution for audibly notifying a user of a communications device.

These and other objects of the invention are achieved by means of different aspects of the invention, as defined by the independent claims. Embodiments of the invention are characterized by the dependent claims.

According to a first aspect of the invention, a communications device for audibly notifying a user of the communications device is provided. The communications device comprises an acoustic actuator and a processing circuitry. The processing circuitry causes the communications device to become operative to capture spoken utterances. The communications device is further operative to estimate a current acoustic damping which the captured spoken utterances have been subjected to. The current acoustic damping is estimated based on an amplitude of the captured spoken utterances and a maximum amplitude of previously captured spoken utterances. The communications device is further operative to audibly notify the user by emitting an acoustic notification signal using the acoustic actuator. The acoustic notification signal is adapted based on the estimated current acoustic damping.

According to a second aspect of the invention, a method of audibly notifying a user of a communications device is provided. The method is performed by the communications device and comprises capturing spoken utterances. The method further comprises estimating a current acoustic damping which the captured spoken utterances have been subjected to. The current acoustic damping is estimated based on an amplitude of the captured spoken utterances and a maximum amplitude of previously captured spoken utterances. The method further comprises audibly notifying the user by emitting an acoustic notification signal using an acoustic actuator comprised in the communications device. The acoustic notification signal is adapted based on the estimated current acoustic damping.

According to a third aspect of the invention, a computer program is provided. The computer program comprises instructions which, when the computer program is executed by a processor comprised in a communications device comprising an acoustic actuator, causes the communications device to carry out the method according to an embodiment of the second aspect of the invention.

According to a fourth aspect of the invention, a computer-readable storage medium is provided. The computer-readable storage medium has stored thereon the computer program according to the third aspect of the invention.

According to a fifth aspect of the invention, a data carrier signal is provided. The data carrier signal carries the computer program according to the third aspect of the invention.

The invention makes use of an understanding that an improved audible notification of a user of a communications device, such as a smartphone, may be realized by relying on a reciprocity of the acoustic channel. This may be achieved by adapting the acoustic notification signal of the communications device in accordance with a current acoustic damping which is estimated based on captured spoken utterances. Advantageously, the acoustic notification signal can be adapted to at least partially compensate for the actual current acoustic damping, rather than increasing the volume of a ring tone or similar by a pre-configured amount.

Even though advantages of the invention have in some cases been described with reference to embodiments of the first aspect of the invention, corresponding reasoning applies to embodiments of other aspects of the invention.

Further objectives of, features of, and advantages with, the invention will become apparent when studying the following detailed disclosure, the drawings and the appended claims. Those skilled in the art realize that different features of the invention can be combined to create embodiments other than those described in the following.

### BRIEF DESCRIPTION OF THE DRAWINGS

The above, as well as additional objects, features and advantages of the invention, will be better understood through the following illustrative and non-limiting detailed description of embodiments of the invention, with reference to the appended drawings, in which:

FIG. 1 illustrates a scenario in which embodiments of the invention may be employed.

FIG. 2 illustrates another scenario in which embodiments of the invention may be employed.

FIG. 3 schematically illustrates a communications device for audibly notifying a user of the communications device, in accordance with embodiments of the invention.

FIG. 4 shows a method of audibly notifying a user of the communications device, in accordance with embodiments of the invention.

All the figures are schematic, not necessarily to scale, and generally only show parts which are necessary in order to elucidate the invention, wherein other parts may be omitted or merely suggested.

### DETAILED DESCRIPTION

The invention will now be described more fully herein after with reference to the accompanying drawings, in which certain embodiments of the invention are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art.

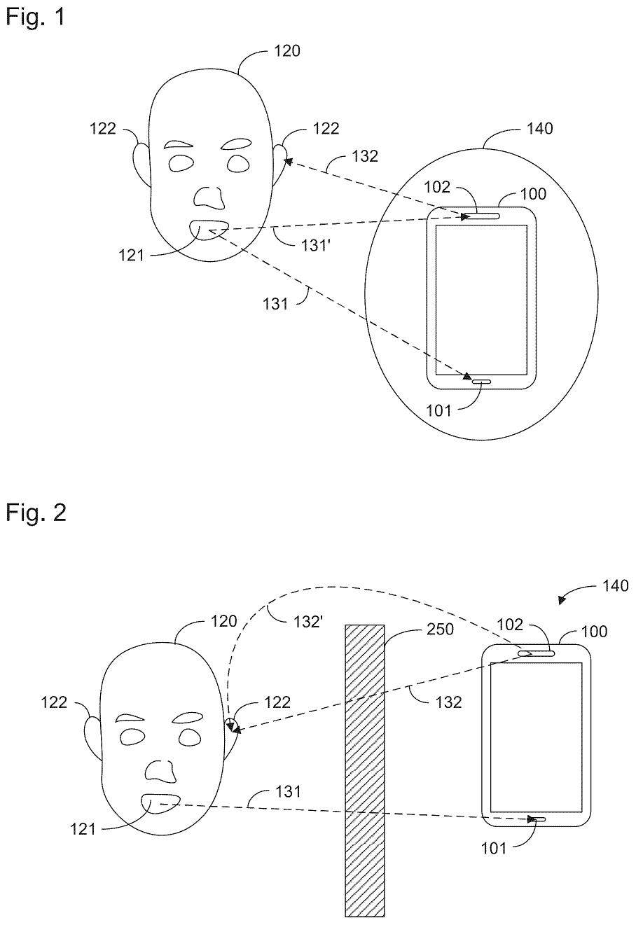

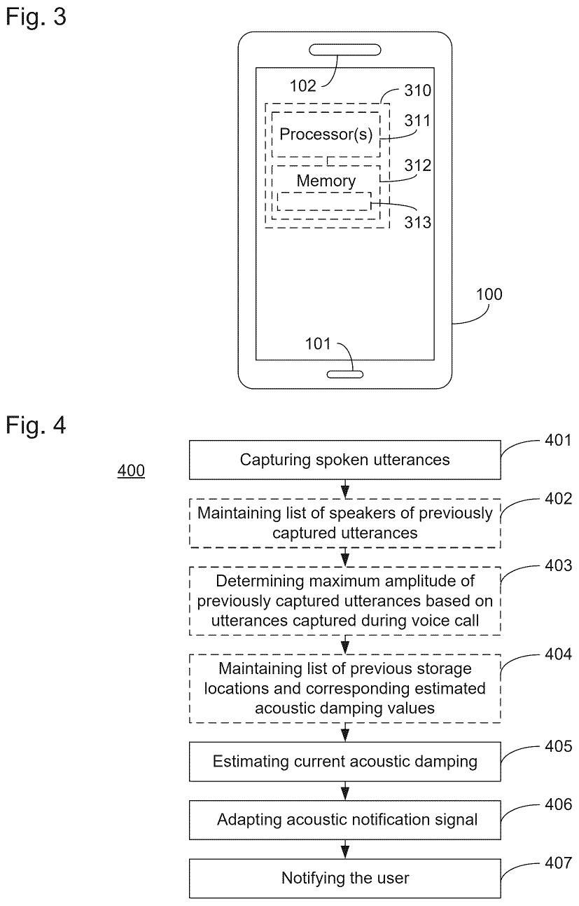

FIGS. 1 and 2 illustrate scenarios in which embodiments of the invention may be employed, in particular the communications device 100 for audibly notifying a user 120 of the communications device 100. Embodiments of the communications device 100 are illustrated in FIG. 3 and described in more detail in the following. The communications device 100 may, e.g., be any one of a mobile phone, a smartphone, a smartwatch, a tablet, a pager, or any other portable computing device which is operative to emit an audible notification.

Embodiments of the invention address an issue which arises when the communications device 100 is placed in a storage location where acoustic notification signals emitted by the communications device 100, e.g., a ring tone which is emitted in response to an incoming call, are acoustically damped along the acoustic path 132 travelled by the sound waves between the communications device 100 and the ear or ears 122 of the user 120. For instance, as is illustrated in FIG. 1, this may be the case if the communications device 100 is placed inside a storage location 140 such as a pocket, a bag, a purse, a backpack, a cupboard, a drawer, or the like, owing to the acoustic damping which the acoustic notification signals suffer when passing the fabric, garment, wood, or other materials, which the storage location 140 is made of. The communications device 100 may also, intentionally or unintentionally, be covered by an object or material which acoustically damps the acoustic notification signal, such as a coat, a jacket, or other piece of clothing, a pillow, a blanket, a newspaper or magazine, or the like.

Another scenario in which embodiments of the invention may be employed is illustrated in FIG. 2. Here, the communications device 100 is separated from the user 120 either by a relatively large distance and/or an obstacle 250, e.g., a wall or curtain, such that the audibility of the acoustic notification signal is negatively impacted owing to the acoustic damping by the obstacle 250 and/or the relatively long acoustic path 132′ travelled by the sound waves.

Throughout this disclosure, a storage location 140 is understood to be a location where the communications device 100 has been placed intentionally or unintentionally, and where its emitted acoustic notification signals are acoustically damped along the acoustic path 132 between the communications device 100 and the ears 122 of the user 120. In the present context, acoustic damping is understood to be the dissipation of energy carried by sound waves carrying the acoustic notification signal.

Embodiments of the invention are based on the understanding that the damping which acoustic notification signals emitted by the communications device 100 suffer along the acoustic path 132 towards the user's ears 122 can be estimated based on the acoustic damping along the reciprocal path 131 between the user's mouth 121 and the communications device 100. Under the assumption the acoustic damping is substantially equal (referred to as reciprocity of the acoustic channel), or at least sufficiently similar, for sound propagating along the acoustic paths 131 and 132, the amplitude, or volume, of acoustic notification signals emitted by the communications device 100 are adjusted based on the acoustic damping estimated for the reciprocal path 131. Thereby, the acoustic damping which acoustic notification signals emitted by the communications device 100 will suffer along the path 132 can be at least partially compensated.

More specifically, and with reference to FIG. 3, the communications device 100 comprises an acoustic actuator 102 and a processing circuitry 310. The acoustic actuator 102 may, e.g., be a loudspeaker, a buzzer, or any other device which is operative to emit an audible sound. The acoustic actuator 102 may optionally be operative to capture sound, as is described further below, similar to a microphone. In practice, this may be the case if the acoustic actuator 102 is a loudspeaker, as the process of converting an electric signal into sound by a loudspeaker also works in the reverse direction.

The processing circuitry 310 may comprise one or more processors 311, such as Central Processing Units (CPUs), microprocessors, application processors, application-specific processors, Graphics Processing Units (GPUs), and Digital Signal Processors (DSPs), or a combination thereof, and a memory 312 comprising a computer program 313 comprising instructions. When executed by the processor(s) 311, the instructions cause the communications device 100 to become operative in accordance with embodiments of the invention described herein. The memory 312 may, e.g., be a Random-Access Memory (RAM), a Read-Only Memory (ROM), a Flash memory, or the like. The computer program 313 may be downloaded to the memory 312 by means of a communications interface circuitry (not illustrated in FIG. 3) as a data carrier signal carrying the computer program 313. The processing circuitry 310 may alternatively or additionally comprise one or more Application-Specific Integrated Circuits (ASICs), Field-Programmable Gate Arrays (FPGAs), or the like, which are operative to cause the communications device 100 to become operative in accordance with embodiments of the invention described herein.

The communications interface circuitry may be operative to support communications with other communications devices, computing devices, and/or communications networks, using a suitable wired or wireless technology and corresponding protocols. For example, the communications interface circuitry may be any one, or a combination of, a cellular modem (e.g., GSM, GPRS, UMTS, LTE, 5G), a Wi-Fi modem, a Bluetooth modem, an Ethernet interface, or the like.

Further with reference to FIG. 3, the communications devices 100 is operative to capture spoken utterances, and to estimate a current acoustic damping which the captured spoken utterances have been subjected to. The estimated current acoustic damping may, e.g., be expressed in decibel, in some device-specific unit, or as a ratio, and is indicative of the acoustic damping along the path 131, i.e., from the user's mouth 121 to the communications device 100. The communications device 100 is operative to estimate the current acoustic damping based on an amplitude of the captured spoken utterances and a maximum amplitude of previously captured spoken utterances. This may be achieved by continuously capturing sound, including spoken utterances which may be extracted from the captured sound by speech recognition, determining an amplitude of the captured spoken utterances, and storing a value representing the maximum amplitude, e.g., in the memory 312. If a spoken utterance with a higher amplitude is subsequently captured, the stored value is replaced with the new maximum amplitude. In order to avoid too frequent changes of the estimated current acoustic damping, the amplitude of the captured spoken utterances may be averaged over a duration of time of a few tens of a second up to few seconds. For instance, a filter such as an Infinite Impulse Response (IIR) may be applied to the captured spoken utterances. The filter may be a low-pass filter, a high-pass filter, a band-pass filter, or a band-stop filter. It will also be appreciated that filters may be used to suppress parts of the acoustic spectrum in the captured audio signal which are not relevant for human utterances.

Alternatively or additionally, the communications device 100 may further be operative to determine the maximum amplitude of the previously captured spoken utterances based on spoken utterances captured during a voice call of the user 120 using the communications device 100. This is based on the assumption that the communications device 100 is held close to the user's head during a voice call. In practice, this means that the user 120 is not using a headset, earbuds with built-in microphone, or the like, but uses the microphone 101 during the voice call.

Preferably, the communications device 100 is operative to estimate the current acoustic damping based on a ratio of the amplitude of the captured spoken utterances and the maximum amplitude of previously captured spoken utterances. The ratio may, e.g., be expressed in decibel. More specifically, if the amplitude of the captured spoken utterances is A and the maximum amplitude of previously captured spoken utterances is Aₘₐₓ, where A and Aₘₐₓ represent quantities like voltage, current, or sound pressure level, the ratio in decibel can be calculated as

$$10 \cdot {log}_{10} ( \frac{{A}^{2}}{{A}_{max}^{2}} ) = 20 \cdot {log}_{10} ( \frac{A}{{A}_{max}} ) .$$

If, on the other hand, A and Aₘₐₓ represent

$$10 \cdot {log}_{10} ( \frac{A}{{A}_{max}} ) .$$

Alternatively, the ratio may simply be expressed as a value between 0 (zero) and 1 (one), or 0 (zero) and 100 (one hundred) percent. For example, if the ratio A/Aₘₐₓ of the amplitude of captured spoken utterances and the maximum amplitude of previously captured spoken utterances is determined to be 0.8, or 80%, this means that the amplitude of the captured spoken utterances is reduced by 20% as compared to the maximum amplitude of previously captured spoken utterances. Expressed in decibel, the current acoustic damping amounts to approximately 1.94 db.

The communications device 100 is further operative to audibly notify the user 120 by emitting an acoustic notification signal using the acoustic actuator 102. The acoustic notification signal is adapted based on the estimated current acoustic damping. Advantageously, the acoustic damping which the acoustic notification signals is subjected to when propagating along the path 132 can thereby be at least partially compensated. Preferably, the communications device 100 is operative to audibly notify the user 120 in response to receiving an incoming call or message. In addition, the communications device 100 may be operative to audibly notify the user 120 in response to any other trigger or event, such as a calendar event, a reminder, or the like.

The communications device 100 may further comprise a microphone 101, and be operative to capture the spoken utterances using the microphone 101. Thereby, and with reference to FIGS. 1 and 2, the current acoustic damping along the path 131 between the user's mouth 121 and the microphone 101 is estimated. As an alternative, the communications device 100 may be operative to capture the spoken utterances using the acoustic actuator 102, e.g., if the acoustic actuator 102 is a loudspeaker. In this case, the current acoustic damping for the path 131′ (not illustrated in FIG. 2) between the user's mouth 121 and the acoustic actuator 102 is estimated. Capturing the spoken utterances using the acoustic actuator 102 is advantageous in that the path 131′ travelled by the spoken utterances is more similar to the path 132 travelled by the acoustic notification signals. Accordingly, the estimated current acoustic damping for the path 131′ does more reliably reflect the acoustic damping along the path 132. In particular, this may be the case if only part of the communications device 100 is covered, e.g., when only the part of the communications device 100 where the acoustic actuator 102 is located, or the part of the communications device 100 where the microphone 101 is located, but not both, is within a pocket or covered by a blanket. As a further alternative, the communications device 100 may comprise a dedicated microphone (not illustrated in FIGS. 1 to 3) which is co-located with the acoustic actuator 102, for the purpose of capturing spoken utterances in accordance with embodiments of the invention.

The communications device 100 may be operative to estimate the current acoustic damping as an average over a frequency range of the captured spoken utterances, e.g., over the frequency range of the human voice. Optionally, the average may be calculated using a weight function which reflects the frequency spectrum of the acoustic notification signal, with increased weights at frequencies or frequency ranges where a substantial part of the acoustic energy of the acoustic notification signal is located. Thereby, the estimated current acoustic damping more reliably reflects the damping which the acoustic notification signals emitted by the communications device 100 are subjected to.

The communications device 100 may alternatively be operative to estimate the current acoustic damping as a frequency dependent current acoustic damping. In other words, the current acoustic damping is not represented by a single value, but rather a vector or multiple values representing the estimated acoustic damping for a number of discrete frequencies within a frequency range. The frequency range for which the current acoustic damping is estimated may be selected based on the frequency range of the human voice and/or the frequency range of the acoustic notification signal.

In the following, different alternatives for adapting the acoustic notification signal based on the estimated current acoustic damping are described.

For instance, the communications device 100 may be operative to adapt the acoustic notification signal by adjusting an amplitude, or volume, of the acoustic notification signal based on the estimated current acoustic damping. This may, e.g., be a ringtone volume for incoming calls, a notification volume for incoming messages, or the like. Preferably, the communications device 100 may be operative to adjust the amplitude of the acoustic notification signal by increasing the amplitude of the acoustic notification signal by the estimated current acoustic damping. In this way, the current acoustic damping is compensated. As an example, if the estimated current acoustic damping is 0.8 or 80%, the amplitude of the acoustic notification signal is increased by a factor of 1/0.8=1.25, i.e., by 25%. Expressed in decibel, the amplitude of the acoustic notification signal is increased by 1.94 db. In practice, the maximum amplitude of the acoustic notification signal may be limited by capabilities of the communications device 100 and/or the acoustic actuator 102, and may additionally be limited to a configurable maximum amplitude which may optionally be dependent on context (e.g., location, time of day, etc). The amplitude of the acoustic notification signal may alternatively be increased to a lesser extent, e.g., by a configurable portion of the estimated current acoustic damping.

As an alternative, the communications device 100 may be operative to adapt the acoustic notification signal by selecting the acoustic notification signal based on the estimated frequency dependent current acoustic damping and a frequency spectrum of the selected acoustic notification signal. In practice, the communications device 100 may be provided with a set of acoustic notification signals having different frequency spectra. Advantageously, the different acoustic notification signals may differ in respect to in which frequency range or ranges a substantial part of their acoustic energy is located. Depending on which frequency range suffers most from the current acoustic damping, an acoustic notification signal may be selected which is likely to be most audible to the user 120. In practice, this may be achieved by selecting an acoustic notification signal which has a substantial part of its acoustic energy at a frequency, or in a frequency range, for which the estimated acoustic damping is relatively low (compared to other frequencies of the frequency dependent current acoustic damping).

As yet a further alternative, the communications device 100 may be operative to adapt the acoustic notification signal by modifying a frequency spectrum of the acoustic notification signal based on the estimated frequency dependent current acoustic damping. Moe specifically, the acoustic notification signal may be modified so that the resulting frequency spectrum has a substantial part of its acoustic energy at a frequency or in a frequency range in which the estimated acoustic damping is relatively low (compared to other frequencies of the frequency dependent current acoustic damping). In practice, this may either be achieved by shifting the entire frequency spectrum to lower or higher frequencies, or by emphasizing (i.e., increasing the amplitude for) parts of the frequency spectrum where the damping is relatively low.

The communications device 100 may optionally be operative to estimate the current acoustic damping based on captured spoken utterances and previously captured spoken utterances which originate from the same speaker, i.e., from the same person. In particular, the speaker may be the user 120 of the communications device 100. This is advantageous in that the acoustic notification signal is typically addressed to the user 120 of the communications device 100. In general, the captured spoken utterances may originate from one or more speakers in the proximity of the communications device 100, which may, or may not, include the user 120 of the communications device 120. It will be appreciated that the ability to capture spoken utterances, i.e., the range around the communications device 100 in which spoken utterances can be captured, depends on the capabilities of the microphone 101 or the acoustic actuator 102 and also the current storage location 140 (and its acoustic damping) of the communications device 100.

Recognizing the speaker of utterances may be achieved by speaker recognition techniques which are applied to the captured spoken utterances, as is known in the art (see, e.g., “Person identification based on voice recognition”, by J. Gomes, H. Fernandes, S. Abraham, and S. Chavan, 2021 4th Biennial International Conference on Nascent Technologies in Engineering (ICNTE), DOI: 10.1109/ICNTE51185.2021.9487756, IEEE (2021)). Speaker recognition typically relies on frequency estimation, hidden Markov models, Gaussian mixture models, pattern matching algorithms, neural networks, matrix representation, vector quantization, decision trees, or the like. In the present context, speaker recognition is to be understood as matching captured spoken utterances to previously captured spoken utterances by the same speaker, for the purpose of estimating the current acoustic damping base on an amplitude of the captured spoken utterances and a maximum amplitude of previously captured spoken utterances. It does not require identifying the speaker by name or the like.

The communications device 100 may further be operative to maintain a list, e.g., a database, of the one or more speakers of the previously captured spoken utterances and corresponding maximum amplitudes for the one or more speakers. For instance, these may be family members, friends, colleagues, or co-workers, which the user 120 of the communications device 100 regularly meets. Accordingly, the communications device 100 is likely to capture utterances spoken by these persons and can use these to estimate the current acoustic damping even though the user 120 is currently not speaking. Therefore, the communications device 100 may be operative to estimate the current acoustic damping based on captured spoken utterances by one of the one or more speakers of the previously captured spoken utterances. In particular, this may be a speaker other than the user 120 of the communications device 100. For instance, this may be the person who has spoken last, i.e., his/her utterances have been captured last, or the person which has spoken most during a certain time interval. In general, this may be the most prominent person as represented by the captured spoken utterances. Estimating the current acoustic damping for any person in the proximity of the communications device 100 is advantageous in that the user 120 may not be speaking all the time. In this way, the current acoustic damping can be estimated based on other persons' spoken utterances.

More specifically, the communications device 10 may further be operative to estimate the current acoustic damping based on captured spoken utterances by the user 120 of the communications device 100, and under the condition that spoken utterances by the user 120 of the communications device 100 have not been captured for more than a threshold time interval, estimate the current acoustic damping based on captured spoken utterances by one of the one or more speakers of the previously captured spoken utterances other than the user. Advantageously, precedence is thereby given to spoken utterances by the user 120 of the communications device 100, as it is him/her who is to be audibly notified, but spoken utterances by other persons in the proximity of the communications devices 100 can be relied upon in case the user 120 is currently not speaking.

The communications device 100 may be operative to capture spoken utterances, and/or estimate the current acoustic damping, and/or adapt the acoustic notification signal, only if the communications device 100 is stored in a storage location, covered, or separated from the user 120. For instance, this may be achieved by detecting that an ambient light intensity is below a threshold value, indicating that the communications device 100 is stored in a closed storage location (see, e.g., U.S. Pat. No. 8,363,857 B2). Alternatively, the communications device 100 may detect the proximity of NFC tags which are placed in different storage locations and thereby identify that it is, e.g., stored in a purse (see, e.g., WO 2009/151833 A1). The distance of the communications device 100 to the user 120 may, e.g., be determined based on detecting a signal strength of a wireless connection between the communications device 100 and a wireless device worn or carried by the user 120, such as a smartwatch, a smart ring, or a fitness tracker.

The communications device 100 may further be operative to maintain a list, e.g., a database, of previous storage locations 140 and corresponding estimated acoustic damping values, and adapt the acoustic notification signal based on a previously estimated acoustic damping at a detected current storage location 140 of the communications device 100. This may be achieved by associating the storage locations with information obtained from one or more sensors comprised in the communications device 100, e.g., gait detection based on sensor readings obtained from an Inertial Measurement Unit (IMU), and/or detected NFC tags. In this way, the communications device 100 can use an estimated acoustic damping from a previous occasion when the communications device 100 was in the same storage location 140. Advantageously, the communications device 100 can thereby adapt the acoustic notification signal even though the user 120, or any other person in the proximity of the communications device 100, is currently not speaking.

In the following, embodiments of a method 400 of audibly notifying a user 120 of a communications device 100 are described with reference to FIG. 4. The method 400 is performed by the communications device 100 and comprises capturing 401 spoken utterances. The method 400 further comprises estimating 405 a current acoustic damping which the captured spoken utterances have been subjected to. The current acoustic damping is estimated 405 based on an amplitude of the captured spoken utterances and a maximum amplitude of previously captured spoken utterances. The method 400 further comprises audibly notifying 407 the user 120 by emitting an acoustic notification signal using an acoustic actuator 102 comprised in the communications device 100. The acoustic notification signal is adapted 406 based on the estimated current acoustic damping.

The current acoustic damping may be estimated 405 based on a ratio of the amplitude of the captured spoken utterances and the maximum amplitude of previously captured spoken utterances.

The current acoustic damping may be estimated 405 as an average over a frequency range of the captured spoken utterances. Alternatively, the current acoustic damping may be estimated 405 as a frequency dependent current acoustic damping.

The spoken utterances may be captured 401 using a microphone 101 comprised in the communications device 100. Alternatively, the spoken utterances may be captured 401 using the acoustic actuator 102.

The acoustic notification signal may, e.g., be adapted 406 by adjusting an amplitude of the acoustic notification signal based on the estimated current acoustic damping. Preferably, the amplitude of the acoustic notification signal is adapted 406 by increasing the amplitude of the acoustic notification signal by the estimated current acoustic damping.

Alternatively, the acoustic notification signal may be adapted 406 by selecting the acoustic notification signal based on the estimated 405 frequency dependent current acoustic damping and a frequency spectrum of the selected acoustic notification signal.

As a further alternative, the acoustic notification signal may be adapted 406 by modifying a frequency spectrum of the acoustic notification signal based on the estimated 405 frequency dependent current acoustic damping.

The current acoustic damping may be estimated 405 based on captured spoken utterances and previously captured spoken utterances which originate from the same speaker. For instance, the speaker may be the user 120 of the communications device 100. In general, the captured spoken utterances originate may from one or more speakers in the proximity of the communications device 100.

The method 400 may further comprise maintaining 402 a list of the one or more speakers of the previously captured spoken utterances and corresponding maximum amplitudes for the one or more speakers. Optionally, the current acoustic damping may be estimated 405 based on captured spoken utterances by one of the one or more speakers of the previously captured spoken utterances. Further optionally, the current acoustic damping may be estimated 405 based on captured spoken utterances by the user 120 of the communications device 100, and the method 400 may further comprise estimating, under the condition that spoken utterances by the user 120 of the communications device 100 have not been captured for more than a threshold time interval, the current acoustic damping based on captured spoken utterances by one of the one or more speakers of the previously captured spoken utterances other than the user 120.

The method 400 may further comprise maintaining 404 a list of previous storage locations and corresponding estimated acoustic damping values, wherein the acoustic notification signal is adapted 406 based on a previously estimated acoustic damping at a detected current storage location 140 of the communications device 100.

The method 400 may further comprise determining 403 the maximum amplitude of the previously captured spoken utterances based on spoken utterances captured during a voice call of the user 120 using the communications device 100. Preferably, the user 120 is audibly notified 407 in response to receiving an incoming call or message.

The capturing 401 spoken utterances, and/or estimating 405 the current acoustic damping, and/or adapting 406 the acoustic notification signal, is/are optionally only performed if the communications device 100 is stored in a storage location 140, covered, or separated from the user 120.

It will be appreciated that the method 400 may comprise additional, alternative, or modified, steps in accordance with what is described throughout this disclosure. An embodiment of the method 400 may be implemented as the computer program 313 comprising instructions which, when the computer program 313 is executed by a processor 311 comprised in a communications device 100 comprising an acoustic actuator 102, cause the communications device 100 to carry out the method 400 and become operative in accordance with embodiments of the invention described herein. The computer program 313 may be stored in a computer-readable data carrier, such as the memory 312. Alternatively, the computer program 313 may be carried by a data carrier signal, e.g., downloaded to the memory 312 via communications interface circuitry.

The person skilled in the art realizes that the invention by no means is limited to the embodiments described above. On the contrary, many modifications and variations are possible within the scope of the appended claims.

1. A communications device for audibly notifying a user of the communications device, the communications device comprising:
an acoustic actuator, and
a processing circuitry configuring the communications device to operate to:
capture spoken utterances,
estimate a current acoustic damping which the captured spoken utterances have been subjected to, based on an amplitude of the captured spoken utterances and a maximum amplitude of previously captured spoken utterances, and
audibly notify the user by emitting an acoustic notification signal using the acoustic actuator, wherein the acoustic notification signal is adapted based on the estimated current acoustic damping.

2. The communications device according to claim 1, further operative to estimate the current acoustic damping based on a ratio of the amplitude of the captured spoken utterances and the maximum amplitude of previously captured spoken utterances.

3. The communications device according to claim 1, further operative to adapt the acoustic notification signal by adjusting an amplitude of the acoustic notification signal based on the estimated current acoustic damping.

4. The communications device according to claim 3, further operative to adjust the amplitude of the acoustic notification signal by increasing the amplitude of the acoustic notification signal by the estimated current acoustic damping.

5. The communications device according to claim 1, further operative to estimate the current acoustic damping as an average over a frequency range of the captured spoken utterances.

6. The communications device according to claim 1, further operative to estimate the current acoustic damping as a frequency dependent current acoustic damping.

7. The communications device according to claim 6, further operative to adapt the acoustic notification signal by selecting the acoustic notification signal based on the estimated frequency dependent current acoustic damping and a frequency spectrum of the selected acoustic notification signal.

8. The communications device according to claim 6, further operative to adapt the acoustic notification signal by modifying a frequency spectrum of the acoustic notification signal based on the estimated frequency dependent current acoustic damping.

9. The communications device according to claim 1, further comprising a microphone, and being further operative to capture the spoken utterances using the microphone.

10. The communications device according to claim 1, further operative to capture the spoken utterances using the acoustic actuator.

11. The communications device according to claim 1, further operative to estimate the current acoustic damping based on captured spoken utterances and previously captured spoken utterances which originate from the same speaker.

12. The communications device according to claim 11, wherein the speaker is the user of the communications device

13. The communications device according to claim 11, wherein the captured spoken utterances originate from one or more speakers in the proximity of the communications device.

14. The communications device according to claim 11, further operative to maintain a list of the one or more speakers of the previously captured spoken utterances and corresponding maximum amplitudes for the one or more speakers.

15. The communications device according to claim 14, further operative to estimate the current acoustic damping based on captured spoken utterances by one of the one or more speakers of the previously captured spoken utterances.

16. The communications device according to claim 15, further operative to:
estimate the current acoustic damping based on captured spoken utterances by the user of the communications device, and
under the condition that spoken utterances by the user of the communications device have not been captured for more than a threshold time interval, estimate the current acoustic damping based on captured spoken utterances by one of the one or more speakers of the previously captured spoken utterances other than the user.

17. The communications device according to claim 16, further operative to determine the maximum amplitude of the previously captured spoken utterances based on spoken utterances captured during a voice call of the user using the communications device.

18. The communications device according to claim 1, further operative to capture spoken utterances, and/or estimate the current acoustic damping, and/or adapt the acoustic notification signal, only if the communications device is stored in a storage location, covered, or separated from the user.

19. The communications device according to claim 1, further operative to:
maintain a list of previous storage locations and corresponding estimated acoustic damping values, and
adapt the acoustic notification signal based on a previously estimated acoustic damping at a detected current storage location of the communications device.

20. (canceled)

21. A method of audibly notifying a user of a communications device, the method performed by the communications device and comprising:
capturing spoken utterances,
estimating a current acoustic damping which the captured spoken utterances have been subjected to, based on an amplitude of the captured spoken utterances and a maximum amplitude of previously captured spoken utterances, and
audibly notifying the user by emitting an acoustic notification signal using an acoustic actuator comprised in the communications device, wherein the acoustic notification signal is adapted based on the estimated current acoustic damping.

22-43. (canceled)
